(19) United States
(12) Patent Application Publication
(10) Pub. No.: US 2002/0053357 A1
(43) Pub. Date: May 9, 2002

(54) Exhaust gas delivering pipe with cleaning device

(75) Inventor: Dong-Soo Kim, Inchon (KR)

Correspondence Address: Kevin G. Rooney, Wood, Herron & Evans, L.L.P., 2700 Carew Tower, Cincinnati, OH, 45202, US

(73) Assignee: KOREA M.A.T.Co. Ltd.

(21) Appl. No.: 09/783,511

(22) Filed: Feb. 14, 2001

(30) Foreign Application Priority Data
Oct. 24, 2000 (KR) 2000-0062564

(51) Int. Cl. B08B 3/00

(52) U.S. Cl. 134/166 R; 55/295

(57) ABSTRACT

An exhaust gas delivering pipe with a cleaning device in which powder buildup can be more effectively prevented. An exhaust gas delivering pipe with a cleaning device in accordance with the present invention comprises a spring placed in the inside of the exhaust gas delivering pipe with a cleaning device, and having an outer circumference which is the same size as the inner circumference of the pipe and a motor installed at the end of the spring to rotate the spring. An elbow box is utilized to connect two or more pipes, and the spring passes through the elbow box and connects to the motors placed on opposite sides of the pipe.

### TECHNICAL FIELD

The present invention relates to an exhaust gas delivering pipe having a cleaning device, and more particularly to an exhaust gas delivering pipe having a cleaning device to prevent powder buildup in an exhaust gas delivering pipe while transferring gases generated during the manufacturing of a semiconductor device to a gas scrubber.

### BACKGROUND

Generally, since the gas generated from a semiconductor manufacturing device contains a high degree of the toxic components, it must be purified before being released to the atmosphere. Therefore, the gas generated during the semiconductor manufacturing process is treated with a gas scrubber which utilizes a burning method, a wetting method or an adsorbent method to remove the toxic components of the gas. The gas scrubber relates to the present invention is explained in detail in the U.S. Pat. No. 5,997,824.

In order to treat the gas generated during the semiconductor manufacturing process, the gas is transferred to the gas scrubber via the exhaust gas delivering pipe. While the gas passes through the exhaust gas delivering pipe, powder builds up on the inner surface of the pipe due to the untreated toxic elements contained in the gas thereof, eventually clogging the pipe.

As illustrated in FIG. 1, in the conventional pipe system, a heating coil 3 is coiled around the outer surface of a pipe 1 and an insulating material 5 is placed on the outer surface of a heating coil to control the changes in temperature of the gas passing through the pipe. However, this conventional method is not effective in preventing a powder buildup on the inner surface of the pipe, and also the energy cost is very high since the pipe needs to be continually heated. Moreover, the pipe needs to be taken apart periodically to clean out the power buildup therein, and the construction of the system is also very complex.

### SUMMARY

Accordingly, it is an object present invention to resolve the foregoing problems of the conventional cleaning device.

It is another object of the present invention to provide an exhaust gas delivering pipe having a cleaning device which effectively prevents the powder buildup.

These and other objects are satisfied by an exhaust gas delivering pipe with a cleaning device comprising: a spring placed in the inside of the exhaust gas delivering pipe with a cleaning device, and having the outer circumference which is the same size as the inner circumference of the pipe; and a motor installed at the end of the spring to rotate the spring.

Other objects are satisfied by an exhaust gas delivering pipe with a cleaning device further comprising an elbow box to connect two or more pipes, and the spring passes through the elbow box and connects to the motors placed on opposite sides of the pipe.

### BRIEF DESCRIPTION OF THE DRAWINGS

FIG. 1 is a fragmentary sectional view of a conventional exhaust gas delivering pipe.

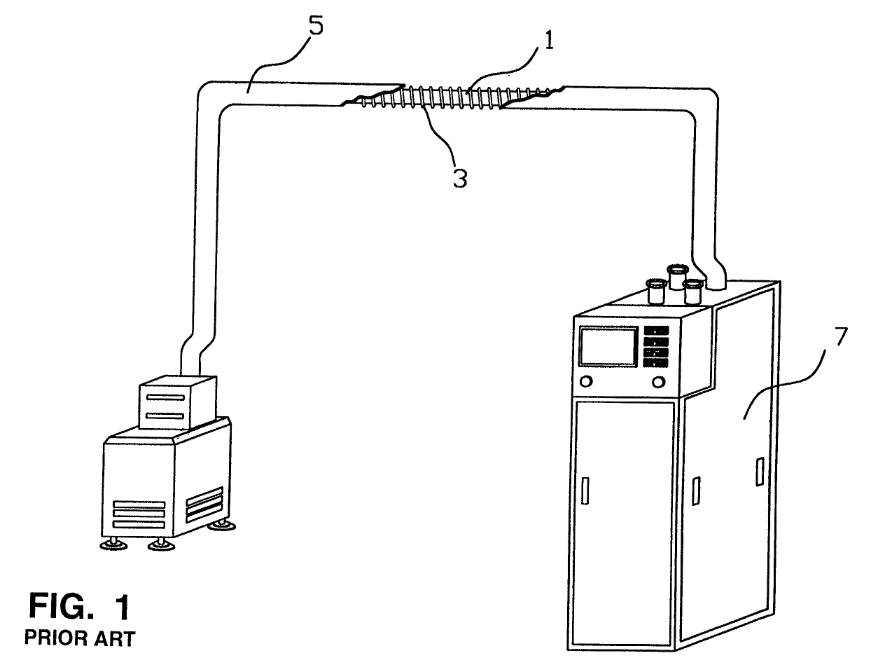

FIG. 2 is a fragmentary sectional view of an exhaust gas delivering pipe having a cleaning device according to the present invention illustrating the first embodiment.

FIG. 3 is a fragmentary sectional view of an exhaust gas delivering pipe having a cleaning device according to the present invention illustrating the second embodiment.

### DESCRIPTION OF THE PREFERRED EMBODIMENTS

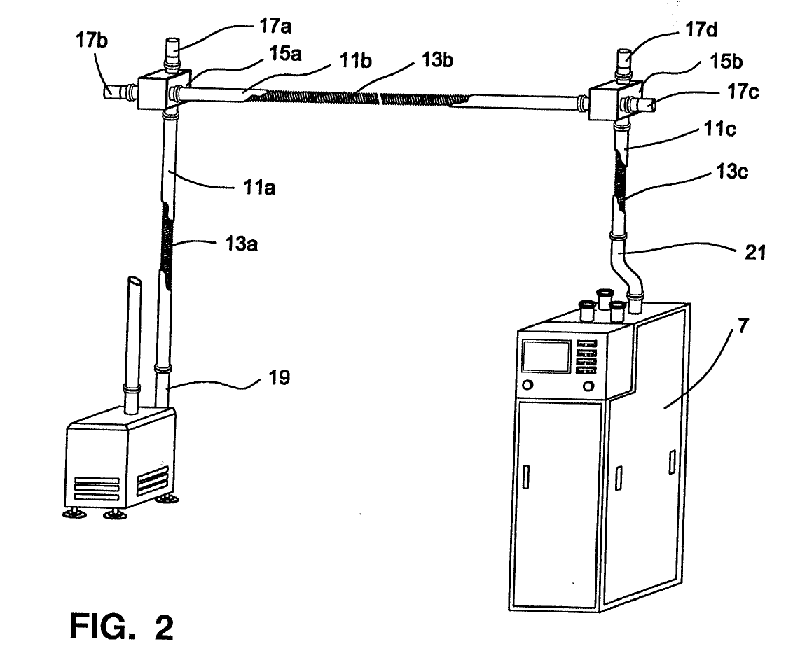

The first preferred embodiment of the present invention is illustrated in FIG. 2. The exhaust gas delivering pipe (11a, 11b, 11c) in accordance with the present invention comprises a spring (13a, 13b, 13c) placed in the inside of the pipe and rotated by motors (17a, 17b, 17c, 17d) placed at the end of the exhaust gas delivering pipe. The size of the spring is almost the same as the inner passage of the pipe (11a, 11b, 11c) such that the outer surface of the spring (13a, 13b, 13c) slightly touches the inner surface of the pipe (11a, 11b, 11c) so that friction is created when the spring (13a, 13b, 13c) rotates. The friction created during the rotation of the spring (13a, 13b, 13c) prevents powder from building up on the inner surface of the pipe. In order to transfer the gas generated during the semiconductor manufacturing process from the manufacturing device to the gas scrubber, the pipe may need to be bent in different angles. The pipe according to the present invention may be bent up to 60 to 70 degrees. Elbow boxes (15a, 15b) are placed at the intersections between two pipes when two pipes are utilized instead of bending one pipe. This occurs in cases where a single pipe needs to be bent more than 70 degrees, for example. The motors (17a, 17b, 17c) are attached to the elbow boxes corresponding to the direction of the pipe (11a and 11b, 11b and 11c) to rotate the springs (13a, 13b, 13c). For example, if the pipe needs to be bent in 90 degrees, the two pipes are used to create 90 degree formation and the elbow box is used to connect the pipes. One of the pipes is attached to one side of the elbow box and other pipe is attached to the other side of the elbow box such that two pipes are vertically placed from each other. The spring (13a, 13b, 13c) passes through the elbow box and connects to the motors (17a. 17b or 17c, 17d) placed on opposite sides of the pipe.

For the portion of the pipe (11a, 11b, 11c) where the spring cannot be installed, such as a valve or a gas exhaust outlet, the conventional method of using a heating coil may be employed. According to the present invention, the conventional method also can be added to this invention to enhance the overall function of preventing the powder buildup.

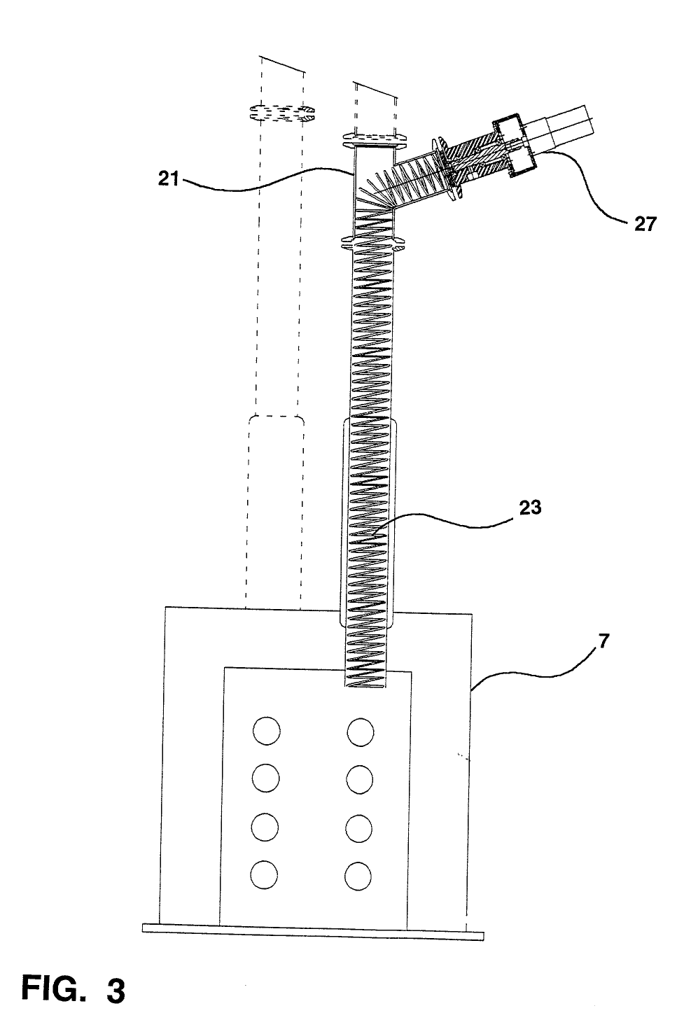

Furthermore, a remote application of the present invention is also possible. Although it is possible to install the spring that prevents the powder buildup throughout all parts of the pipes, the spring may be installed only at the places, such the part of the pipe 21 that connects to the gas scrubber 7, where the powder buildup is much greater than other parts of the pipe. FIG. 3 illustrates the part of the pipe 21 that connects to the gas scrubber 7 in which the spring 23 is installed at the part of the pipe placed near the gas scrubber 7, and the motor 27 is attached at one end of the spring 23.

The following describes the operation of the exhaust gas delivering pipe with a cleaning device in accordance with the present invention.

When the gas generated from the semiconductor manufacturing device passes through the exhaust gas delivering pipe having 15 a cleaning device 11a, 11b, 11c, 21 in accordance with the present invention, the spring 13a, 13b, 13c, 23 is rotated by the motor to generate friction. As a result, instead of sticking to the inner surface of the pipe, the powder particles flow into the gas scrubber 7 which is then purified by the gas scrubber.

The exhaust gas delivering pipe with a cleaning device of the present invention utilizes a mechanical method to prevent the powder buildup. It is more efficient than the conventional method which employs a heating method, and much less energy is required to operate the exhaust gas delivering pipe with a cleaning device of the present invention. Furthermore, since the exhaust gas delivering pipe with a cleaning device in accordance with the present invention which utilizes the friction generated between the inner surface of the pipe and the spring is very effective in preventing the powder buildup, the pipe may not need to be taken apart for cleaning. Therefore, maintenance is much more convenient.

Although the invention has been shown and described with respect to detailed embodiments thereof, it should be understood by those skilled in the art that various changes and omissions in form and detail may be made therein without departing from the spirit and the scope of the invention.

What is claimed is:

1. An exhaust gas delivering pipe with a cleaning device comprising:
(a) a spring placed in the inside of the exhaust gas delivering pipe with a cleaning device, and having the outer circumference which is the same size as the inner circumference of the pipe; and
(b) a motor installed at the end of the spring to rotate the spring.

2. An exhaust gas delivering pipe with a cleaning device according to claim 1 further comprising an elbow box to connect two or more pipes, wherein the spring passes through the elbow box and connects to the motors placed on opposite sides of the pipe

3. An exhaust gas delivering pipe with a cleaning device according to claim 1, wherein a heating coil is placed at a part of the pipe where the spring cannot be installed.

4. An exhaust gas delivering pipe with a cleaning device according to claim 1, wherein the spring is installed at a part of the pipe that connects to the gas scrubber.

5. An exhaust gas delivering pipe with a cleaning device according to claim 2, wherein a heating coil is placed at a part of the pipe where the spring cannot be installed.
